(19) United States
(12) Patent Application Publication
(10) Pub. No.: US 2022/0083940 A1
(43) Pub. Date: Mar. 17, 2022

(54) Intelligent and Automatic Generation of Construction Rule Set

(71) Applicant: Accenture Global Solutions Limited, Dublin (IE)

(72) Inventors: Neda Abolhassani, San Mateo, CA (US); Teresa Sheausan Tung, Tustin, CA (US)

(73) Assignee: Accenture Global Solutions Limited, Dublin (IE)

(21) Appl. No.: 17/459,733

(22) Filed: Aug. 27, 2021

Related U.S. Application Data
(60) Provisional application No. 63/078,611, filed on Sep. 15, 2020.

(51) Int. Cl. G06Q 10/06; G06Q 10/08; G06Q 50/08; G06Q 10/10; G06F 16/245; G06F 30/12; G06F 3/0482

(52) U.S. Cl. CPC G06Q 10/06313; G06Q 10/0875; G06Q 50/08; G06F 3/0482; G06F 16/245; G06F 30/12; G06Q 10/103

(57) ABSTRACT

A method and system automatically and intelligently generate rule sets for constructing objects of a construction or assembly project. The method includes extracting various objects from layout data of the project and generating base construction rule sets for these objects. The method further includes automatic extraction of historical construction rule sets for the objects that are similar to the base construction rule sets. Similarities between the base construction rule sets and the historical construction rule sets are calculated based on both construction resource overlap between the base construction rule sets and the historical construction rule sets, and a measure of existence of complementary construction resource pairs in the base construction rule set.

### CROSS REFERENCE

This application is based on and claims priority to U.S. Provisional Application No. 63/078,611 filed on Sep. 15, 2020, which is herein incorporated by reference in its entirety.

### BACKGROUND

### Technical Field

This application relates to a computer system and method to assist in construction or assembly projects.

### Description of Related Art

Projects for constructing buildings, plants, and other facilities, and for assembling machineries typically involve complex procedures for each component/subassembly of the projects. Timely and efficient completion of these projects depends on many factors such as availability and cost of resources including but not limited to construction equipment, consumable materials, and various types of crews. Construction of each of these components/subassemblies may be based on one or more construction rule sets. Manual generation of such construction rule sets is time-consuming and error-prone, and may be impractical for large scale construction or assembly projects.

### BRIEF SUMMARY

The disclosure below describes various implementations of an automatic and intelligent scheduling method and system, which may be used for construction, assembly and other projects. The disclosed implementations particularly provide a system and method for automatically generating, optimizing, selecting, and modifying construction rule sets of components/subassemblies in a construction project, and for integrating the construction rule sets into a project schedule. For a particular component/subassembly, a base rule set is automatically generated. In some embodiments, the base rule set generation of the particular component/subassembly involves automatic extraction of the component/subassembly from a project layout, extraction of processes/tasks, materials, costs, crew, and other resource requirements for construction of each component/subassembly from one or more catalogs and manual databases, and integration of the extracted information into the base rule set for the component/subassembly. Historical construction rule sets of components/subassemblies having a type similar to that of the particular component/subassembly are further extracted from a historical rule set database and are selected for recommendation based on their similarity to the base rule set generated from the catalogs and manuals. In the above and further embodiments, these selected historical rule sets along with the base rule set may be presented to a user for modification and for determination of a final rule set for the particular component/subassembly for integration into the project scheduling. In the above and other further embodiments, the final rule set of the particular component/subassembly is further recorded as part of a evolving pool of historical rule sets. Accordingly, valuable engineering knowledge and expertise in various domains may be automatically accumulated and embedded in the historical rule sets and may be used in the automatic determination of a final rule set for components/subassemblies in future construction projects.

The system and method disclosed herein further provide an option to compare between the base rule set of the particular component/subassembly and historical rule sets for components/subassemblies of a similar type in terms of resource similarity, resource costs, construction durations, and other attributes. In comparing the similarity between the base rule set and historical rule sets, the disclosed system and method not only take into consideration overlaps of various construction resources between the rule sets but also optionally promote rule sets that contain key complementary resources for building components/subassemblies of a particular type in the rule set selection process.

### BRIEF DESCRIPTION OF THE DRAWINGS

FIG. 1 illustrates various resources that affect a construction or assembly project.

FIG. 2 illustrates an exemplary computer system for assisting in a construction or assembly project.

FIG. 3 illustrates an exemplary logic flow for generating a base rule set for constructing/assembling a component/subassembly of a construction or assembly project.

FIG. 4 illustrates exemplary data items used for generating a rule set for constructing/assembling a component/subassembly of a construction or assembly project.

FIG. 5A illustrates exemplary data items as input for generating a rule set for constructing/assembling a component/subassembly of a construction or assembly project.

FIG. 5B illustrates additional exemplary data items as input for generating a rule set for constructing/assembling a component/subassembly of a construction or assembly project.

FIG. 5C illustrates further exemplary data items as input for generating a rule set for constructing/assembling a component/subassembly of a construction or assembly project.

FIG. 5D illustrates exemplary base rule sets generated for a particular component/subassembly of a construction or assembly project.

FIG. 6 shows an exemplary version control of rule sets for constructing/assembling a component/subassembly of a construction or assembly project.

FIG. 7 illustrates an exemplary comparison between candidate construction/assembly rule sets of a component/subassembly of a construction or assembly project in various predetermined dimensions.

FIG. 8 illustrates an exemplary Pointwise Mutual Information (PMI) matrix for construction resources.

FIG. 9 shows an exemplary implementation block diagram of the planning engine of FIG. 2.

FIG. 10 illustrates an exemplary computing device that may be used to implement various computing components of the systems described in the figures above or in the disclosure below.

### DETAILED DESCRIPTION

The disclosure will now be described in detail hereinafter with reference to the accompanied drawings, which form a part of the present disclosure, and which show, by way of illustration, specific examples of embodiments. The disclosure may, however, be embodied in a variety of different forms and, therefore, the covered or claimed subject matter is intended to be construed as not being limited to any of the embodiments to be set forth below. Further, the disclosure may be embodied as methods, devices, components, or systems. Accordingly, embodiments of the disclosure may, for example, take the form of hardware, software, firmware or any combination thereof.

In general, terminology may be understood at least in part from usage in context. For example, terms, such as “and”, “or”, or “and/or,” as used herein may include a variety of meanings that may depend at least in part upon the context in which such terms are used. Typically, “or” if used to associate a list, such as A, B or C, is intended to mean A, B, and C, here used in the inclusive sense, as well as A, B or C, here used in the exclusive sense. In addition, the term “one or more” or “at least one” as used herein, depending at least in part upon context, may be used to describe any feature, structure, or characteristic in a singular sense or may be used to describe combinations of features, structures or characteristics in a plural sense. Similarly, terms, such as “a”, “an”, or “the”, again, may be understood to convey a singular usage or to convey a plural usage, depending at least in part upon context. In addition, the term “based on” or “determined by” may be understood as not necessarily intended to convey an exclusive set of factors and may, instead, allow for the existence of additional factors not necessarily expressly described, again, depending at least in part on context.

Turning to the subject matter of this disclosure, projects for constructing buildings, plants, and other facilities, as well as projects for assembling machineries and other components typically involve complex procedures. Timely and efficient completion of these projects depends on many factors such as availability and cost of construction resources including but not limited to equipment, consumable material, various types of crews, and the like. These projects are generally referred to as construction projects in this disclosure and broadly cover any type of building, assembling, manufacturing, installation projects, and the like.

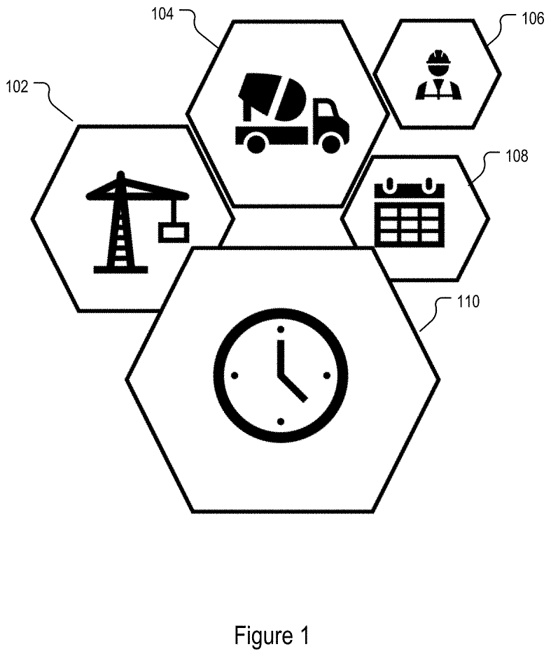

A construction project typically involves sophisticated stages of planning, preparation, construction, and inspection. Project scheduling is thus critical in providing coordination guidelines between various crews and teams throughout a duration of planning and execution of the construction project. As shown in FIG. 1, such scheduling may include a listing of tasks, resources needed for the tasks (such as equipment 102 and 104, and crews 106), project milestones (108), and planned start and end dates for the project (110). In generating the project scheduling, optimization of cost and duration of the construction project through various milestones may be performed, and bottlenecks during the construction project may be identified and considered to avoid excessive delays. The project scheduling may further provide a blueprint for monitoring a progress of the construction project. In some implementations, complex project scheduling may further include what-if planning to specify options and modifications of milestones and start/end dates that may be implemented in case of potential deviation from a normal expected course.

Manual planning of complex construction projects from scratch or based on existing template schedule may be time consuming and error-prone, and may be impractical for large-scale construction projects. As such, automation of the construction planning process has become critical to achieve timely and cost-effective completion of these large construction projects.

Each of these construction projects may generally include multiple phases and/or and each phase may involve dependent or independent components or subassemblies (collectively referred to as objects in this disclosure). Construction of some of these objects may also involve a series of stages or steps of different tasks, and may require different types of crews, equipment, and materials for these different tasks. The construction of such an object may be specified and guided by a construction rule set. Such a rule set may be alternatively referred to as a construction recipe and may include, for example, a sequence or sequences of tasks needed to construct the object. Such rule set may further include interdependency between the tasks, and construction resources required for each task. Again, manual generation of such a construction rule set for each of the objects of the construction project is time-consuming and impractical as the complexity for constructing the various objects increases. The collection of the various inter-dependent or independent rule sets for the objects forms a blueprint for the entire construction project.

The disclosure below describes various implementations for an automatic and intelligent construction project scheduling. The disclosed implementations particularly provide a system and method for automatically generating, optimizing, selecting, and modifying construction rule sets of objects in a construction project, and integrating the construction rule sets into a project schedule. For a particular object, a base rule set may be automatically generated. The base rule set generation of the particular object may involve automatic extraction of the object from a project layout. The base rule set generation of an object may further involve extraction of processes/tasks, materials, costs, and crew requirements for the construction of the object from one or more catalogs and other types of databases, and may also involve integration of the extracted information into the base rule set.

Historical rule sets of objects having a type similar to that of the particular object may be further extracted from a historical rule set database and are selected based on their similarity to the base rule set generated from the catalogs and manuals. These selected historical rule sets along with the base rule set may be presented to a user for inspection, for modification, and for determination of a final rule set of the particular object for integration into the project scheduling. The final rule set of the particular project is further recorded as part of the evolving pool of historical rule sets. As such, valuable engineering knowledge and domain expertise may be automatically accumulated and embedded in the historical rule sets and may be used in the determination of a final rule set for another object in the future. The system and method disclosed herein further provide an option for the user to compare between the base rule set of the particular object and historical rule sets for objects of similar type in terms of similarity in resource requirement, resource costs, construction durations, and the like. In comparing a similarity between the base rule set and historical rule sets, the system and method disclosed herein not only take into consideration overlaps of resources between the rule sets but also promote rule sets that contain key complementary resources for building objects of a particular type in the rule set selection process.

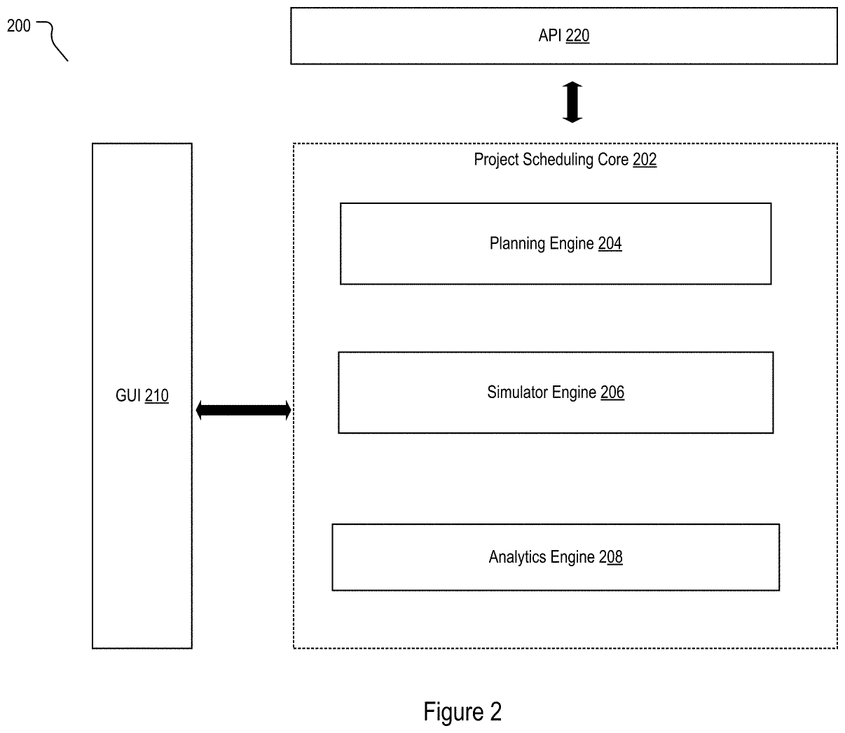

FIG. 2 illustrates a computer-aided construction scheduling system 200. The system may include a project scheduling core 202 that communicates with a Graphical User Interface (GUI) 210. The GUI 210 is provided for receiving control and data input from one or more users via the graphical user interface control elements, and for displaying various output from the project scheduling core 202. The project scheduling core 202 may be configured to perform automatic generation, optimization, and selection of rule sets for various objects of a construction project, integration of the selected rule sets of the various objects into a project schedule, and to perform simulation of a progression of the construction project and other analytics of the construction project based on the rule sets and project schedule. The project scheduling core 202 may include individual servers or clusters of servers that are either centralized or distributed in a communication network (not shown in FIG. 2). The GUI 201 may reside in one or more remote computing devices operated by the one or more users. The one or more remote computing devices may communicate with the project scheduling core 202 via the communication network. The communication network may include any types of wireline or wireless communication systems and their combinations.

As shown in the exemplary implementation of FIG. 2, the project scheduling core 202, in accordance with its functionalities described above, may include a planning engine 204, a simulator engine 206, and an analytics engine 208. The planning engine 204, for example, may be responsible for generation, optimization, selection, modification, and finalizing rule sets associated with construction objects of a construction project as extracted from corresponding project layout. The simulator engine 206, for example, may be responsible for providing constraint resolution and simulation of the construction process with various options that may be taken. The analytics engine 208, for example, may be responsible for performing various analytics of a construction project and providing visualization of the project to users, including but not limited to generating Gantt schedules, cost estimate, and 4D analytics.

As further shown in FIG. 2, Application Programing Interface (API) 220 may be used for the project scheduling core 202 to access functionalities provided by other tools. For example, for generating project scheduling, the project scheduling core 202 may utilize functionalities provided via API by construction scheduling tools such as Oracle Primavera and tools developed by ALICE Technologies. For another example, various analytics functionalities used in the analytics engine 208 of the project scheduling core 202 may also be provided via API 220.

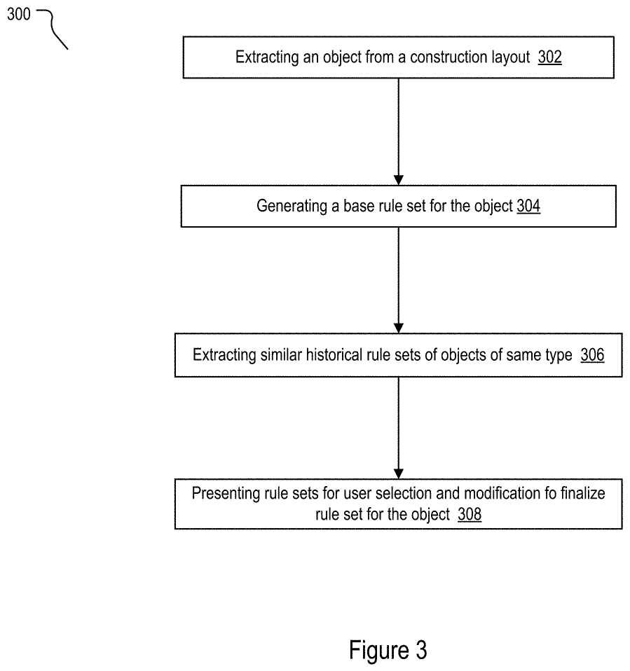

FIG. 3 shows an exemplary logic flow 300 for obtaining a construction rule set for an object of the construction project as extracted from the input construction layout. As shown in step 302, the planning engine 204 of FIG. 2 may extract various objects from a digitized construction layout, schematic, or blueprint (collectively referred to as “construction layout”). Specifically, the construction project may be represented by a construction layout. The construction layout may be compiled in various electronic data formats. Various objects within the construction layout data may be extracted by the planning engine 204. The extracted objects may be characterized by various properties. For example, an extracted object may be of a particular type associated with particular electric, mechanical, physical, and other characteristics. As a particular example, the object may include a horizontal pump within a construction project of a chemical plant. The horizontal pump, for example, may be associated with its physical size, footprint, electric power, and the like. These properties may be extracted from the electronic or digitized construction layout data (including, e.g., schematic and other layout data items).

As further shown in Step 304, the planning engine 204 of FIG. 2 may automatically generate a base rule set of each construction object extracted in step 302. As shown in step 306, the planning engine 204 of FIG. 2 may further extract one or more historical rule sets for objects of similar type. These rule sets may be embedded with engineering domain knowledge and expertise accumulated from prior projects. In step 308, the planning engine 204 of FIG. 2 may present, via the GUI 210 of FIG. 2, the various rule sets (including the base rule set and historical rule sets) for user selection and modification to finalize the rule set for a particular construction object. Exemplary detailed implementations of steps 304-306 are given below.

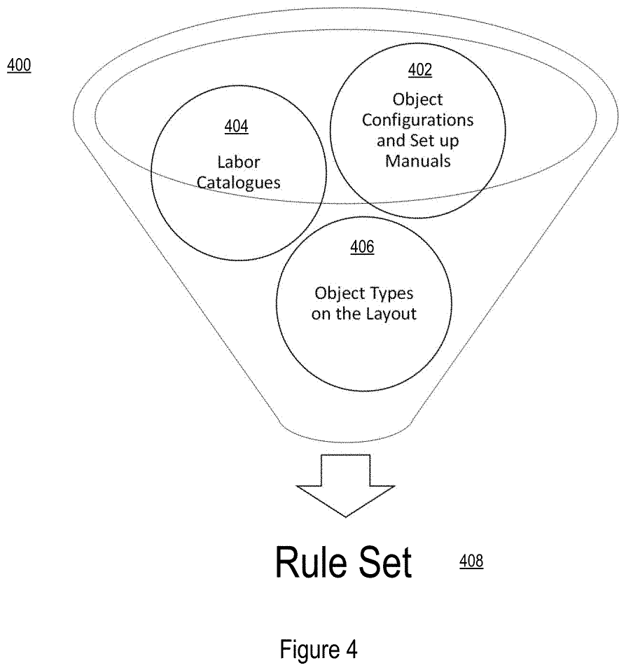

FIG. 4 illustrates an exemplary implementation for automatically generating the base rule set 408 for a construction object in step 304 of FIG. 3. Specifically, the automatic generation of the base rule set 408 may be based on first identifying a set of data sources 400 associated with the object extracted from a digitized construction layout in step 302, and generating the base rule set 408 from the set of data sources. The data resources, for example, may include but are not limited to configuration information of the object (402 of FIG. 4), labor catalogs for the object (404 of FIG. 4), type of the object as specified in a digitized construction layout (406 of FIG. 4), construction manual (e.g., installation/construction manual or guide provided by a manufacturer of the object, 402 of FIG. 4), and other data items such as information for construction equipment and consumable material requirements. The labor catalog 404 may include crew information for different types of tasks and crew cost. The object configuration information 402 may include various properties of objects as described above. The object type information 406 may be organized in any object categorization scheme (including a hierarchical scheme). The construction/installation manual/guidelines among 402 may include steps and resources needed for constructing/installing the object and may depend on various properties of the object (e.g., physical size and/or electric power of the horizontal pump described above).

These data sources 400 of FIG. 4 may be pre-collected as various electronic files or other data formats in a catalog/manual database (referred to as “catalog database” for simplicity). The planning engine 204 of FIG. 2 may be configured to automatically extract relevant data files and/or data items from the catalog database in electronic form for the generation of the base rule set 408. The generation of the base rule set, for example, may involving joining and fusing relevant data items extracted from the data sources 400 into the rule set 408.

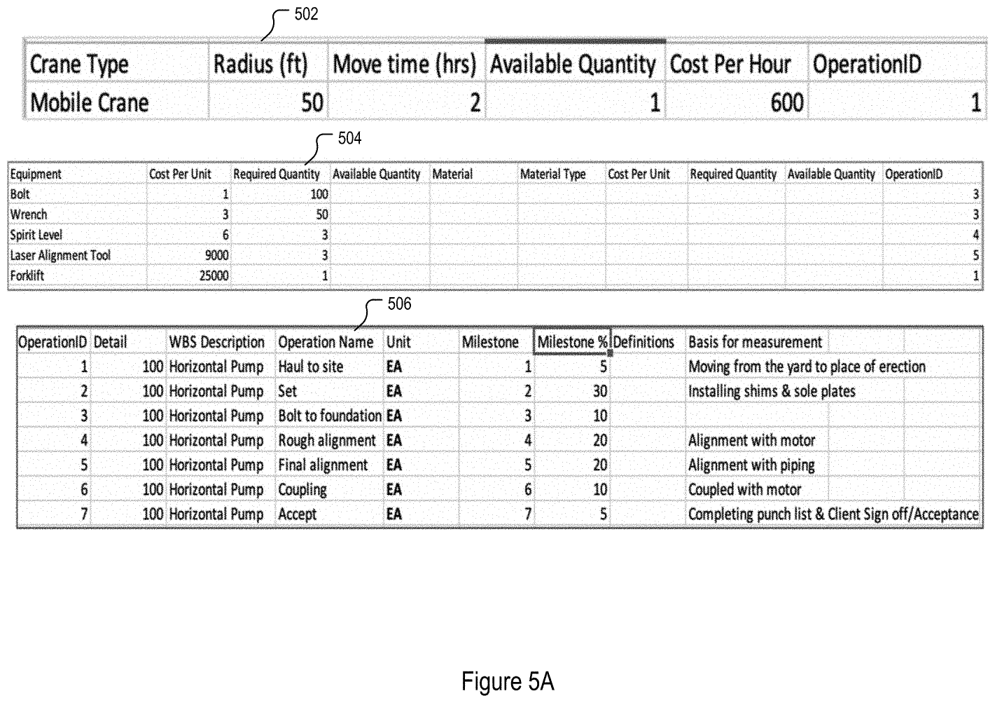

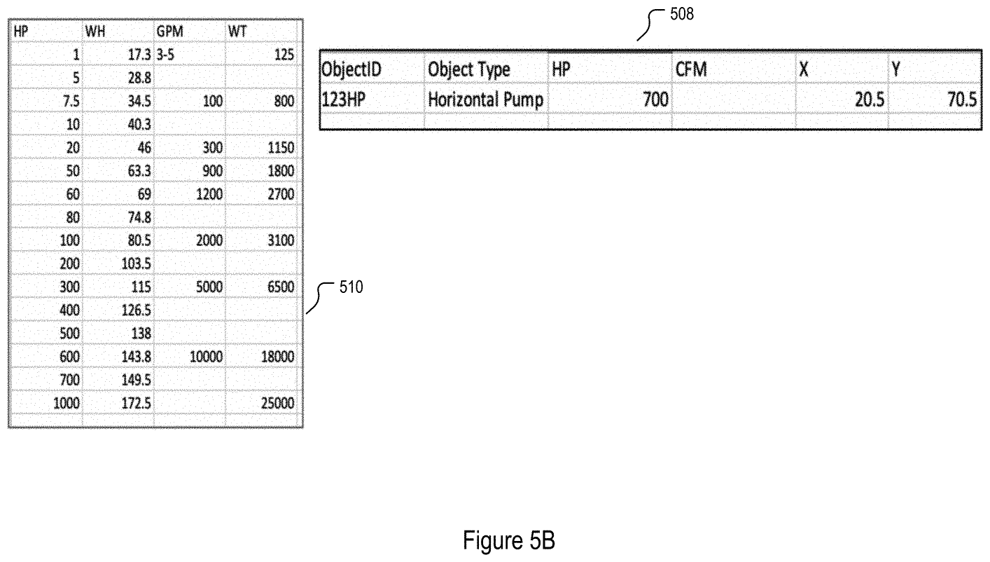

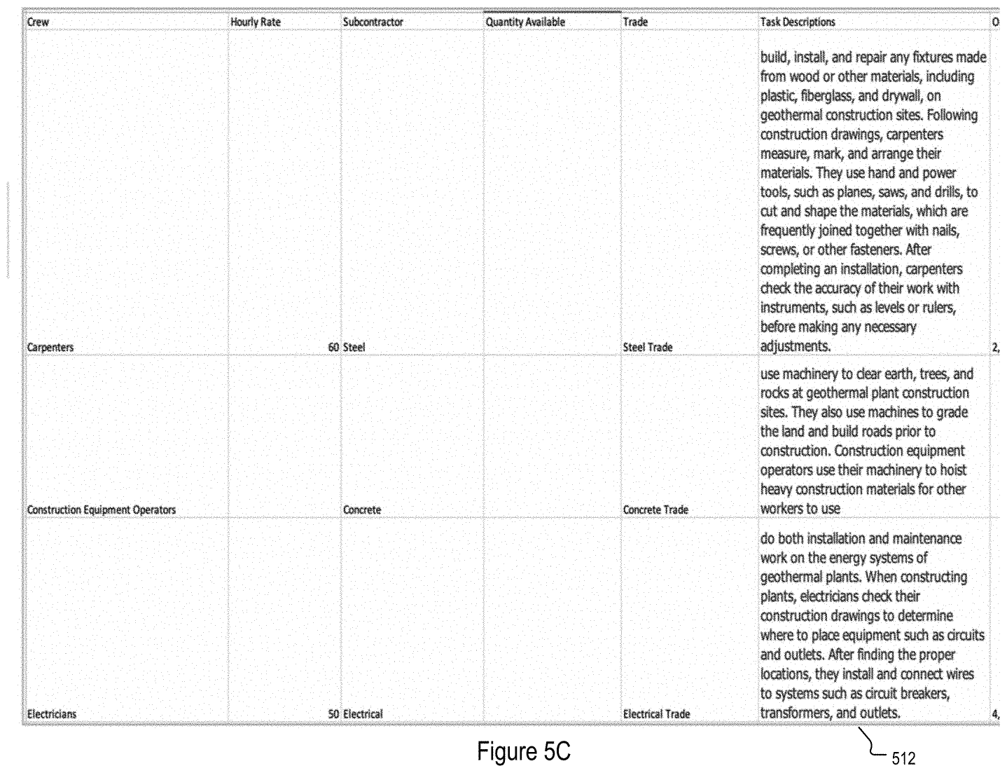

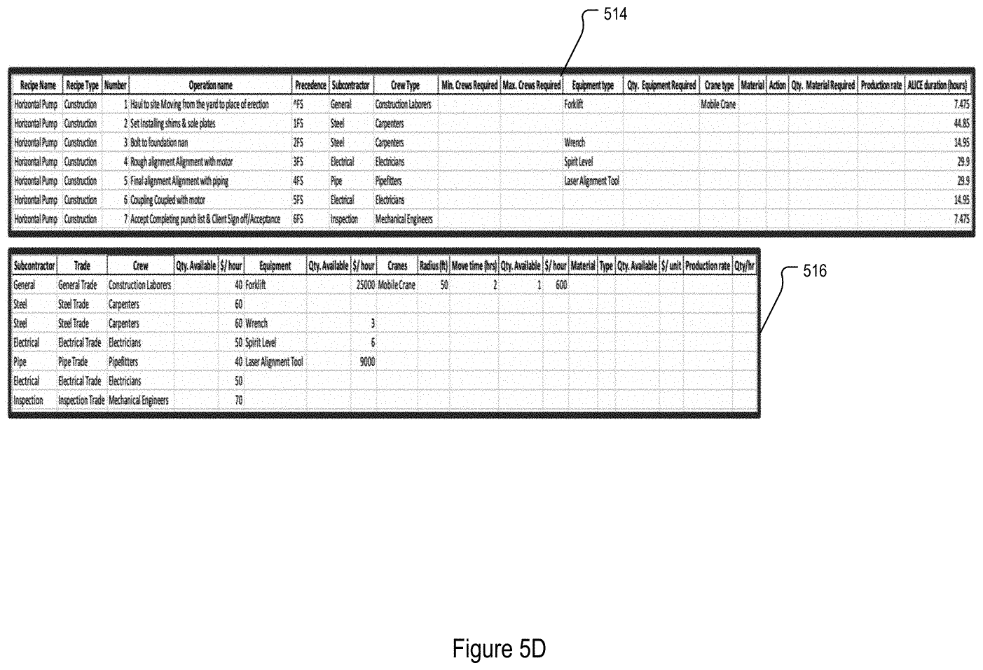

FIGS. 5A-5D show examples of automatically joining various data items extracted from the data sources 400 of FIG. 4 to generate the base rule set for a construction object. For example, data items 502, 504, 506, 508, 510, and 512 that are extracted from the data sources 400 according the properties of the object may be analyzed, combined/joined to form the construction rule set 514 and 516 for the object. As an example, the object extracted from the project layout includes a horizontal pump to be constructed/installed in a chemical plant construction project. The data items extracted from the data sources 400 of FIG. 4 may include but are not limited to, for example, crane resource information 502 (FIG. 5A), equipment and consumable material information 504 for crane installation (FIG. 5A), installation guide information 506 from, e.g., installation manual for the horizontal pump (FIG. 5A), object types and properties 508 and 510 (including horse power rating, footprint, and mechanical information, FIG. 5B), and construction labor/crew information 512 (FIG. 5C).

Such data items from the various data sources may be processed and joined to form the exemplary rule set shown by 514 and 516 in FIG. 5D. The joining of the data items, for example, may begin with the construction guidelines 506 extracted from the installation manual of the object. Each required step may be used as index to obtain resource, labor, cost, and other information from the other data items to complete the generation of the rule set 514 and 516 of FIG. 5D.

The rule set 514 and 516 may contain a recipe for the construction of the object. For example, the rule set 514 may include a sequence or a plurality of sequences of steps or tasks that are needed to construct the object. Resources such as consumable materials, crews, construction equipment, and the like are specified for each of the steps or tasks. Construction duration and cost for each of the steps/tasks may also be specified. Crews may be specified as subcontractors and subcontractor information may be further specified in 516 of FIG. 5 as part of the rule set.

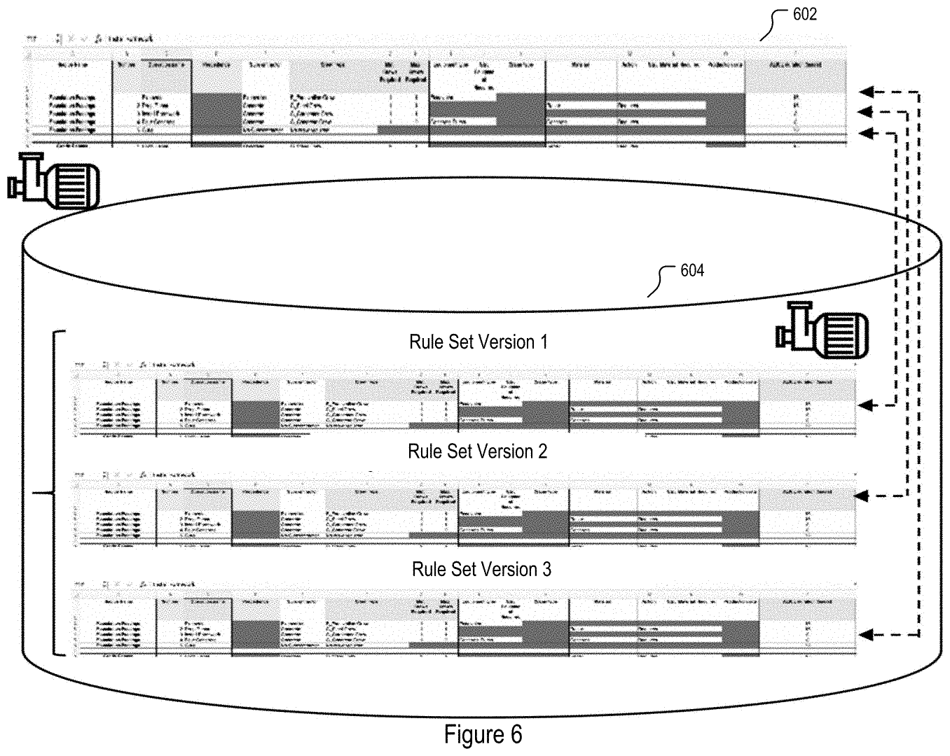

Returning to FIG. 3, once the base rule set is generated in step 304 and as described in detail above in relation to FIG. 4 and FIGS. 5A-5D, a set of historical rule sets similar to the base rule set 514 and 516 of FIG. 5D may be selected from the historical rule set database in step 306. For example, a plurality of objects of the same type as the object associated with the extracted base rule set may be identified from the historical rule set database. Historical rule sets for the plurality of objects may be extracted and compared with the base rule set to identify the rule sets in the historical rule sets that are similar to the base rule set. The collection of similar historical rule sets may be provided along with the base rule set to a user for modification and selection via the user graphical interface 210 of FIG. 2. The combination of the collection of similar historical rule sets and the base rule set together integrate the base rule set generated from the catalogs and manuals with engineering domain knowledge accumulated in the historical rule sets from previous construction projects. The user may be presented with these rule sets for review, modification, and selection. As shown in FIG. 6, both the base rule set 602 and the various modified rule sets 604 by the user may be stored in the historical rule set database, e.g., as different versions, and may be used as part of the historical rule sets for recommendations and selections by user for future construction projects.

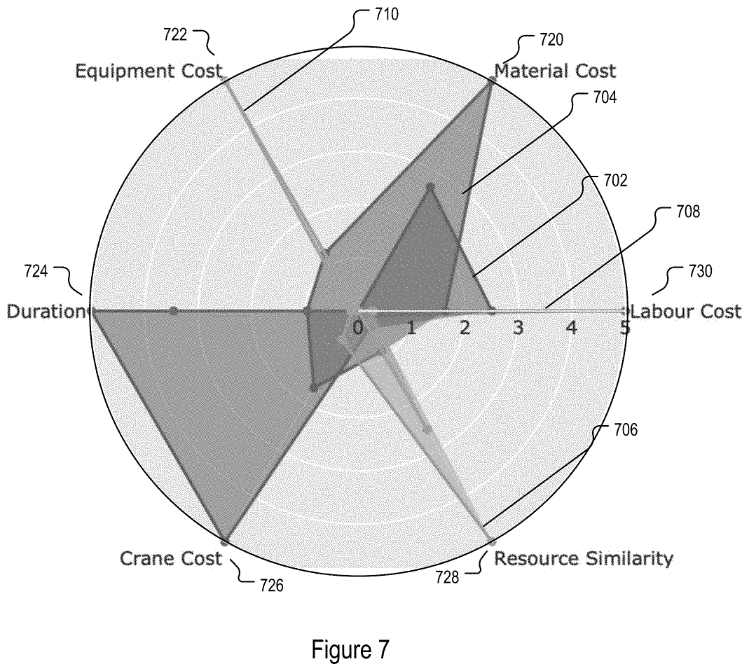

The base rule set and the collection of historical rule sets may be compared in various aspects. An example graphical comparison is shown in FIG. 7 in the context of construction of a column object of an example building construction project. The rule sets being compared are all from the same type of object (columns). For example, Column 702 in FIG. 7 represents a base rule set generated from catalogs and manuals whereas Columns 704, 706, 708, and 710 represent historical rule sets for similar columns. Such a comparison may be made in this example in various aspects or multiple dimensions including but not limited to material cost (radio axis 720), equipment cost (radio axis 722), duration (radio axis 724), crane cost (radio axis 726), construction resource similarity (radio axis 728), and labor cost (radio axis 730), as shown in FIG. 7. The example of FIG. 7 shows that among the rule sets for the various columns, column 710 has the highest equipment cost, column 720 has the highest material cost, column 702 has the longest duration and highest crane cost, column 706 has the highest resource similarity, and column 730 has the highest labor cost.

Resource similarity between the base rule set and each of the historical rule sets may be determined in various manners. For example, such a similarity may be determined based on two main factors. The first main factor, for example, may include an overlap of construction resources between the base rule set and the historical rule sets. The second main factor, for example, may be based on a number of key complementary resources in constructing an object of this specific type. The similarity may be determined as a combination of these two main factors normalized and scaled to a similarity value between a minimum and maximum similarity values. Exemplary implementations are given below. While the similarity determination implementations below are provided for obtaining similarity between the base rule set and a historical rule set, the underlying principles are applicable for deriving similarity evaluation between any two rule sets.

As an example, the resource overlap factor described above may be determined using a Jaccard index. Specifically, an overlap in construction resources between the base rule set and a historical rule set may be determined as:

$$Jacard Index = \frac{Res o u r c {e}_{oldruleset} ⋂ Researc {h}_{n e w r u l e s e t}}{Res o u r c {e}_{oldruleset} ⋃ Resea r c {h}_{n e w r u l e s e t}}$$

where the numerator above denotes overlapping construction resources (equipment, materials, crews and the like) between the base rule set and the historical rule set, whereas the denominator represents a union of construction resources between the resources of the two rule sets.

In some implementations, the key complementary resource factor for constructing a specific object type, for example, may be determined based on a Pointwise Mutual Information (PMI) analysis. First, a general PMI matrix for all construction resources may be created. This matrix may indicate how each pair of equipment, crews or materials appear together in a rule set and thus may be used to identify important complementary construction resources that characterize an object of a particular type.

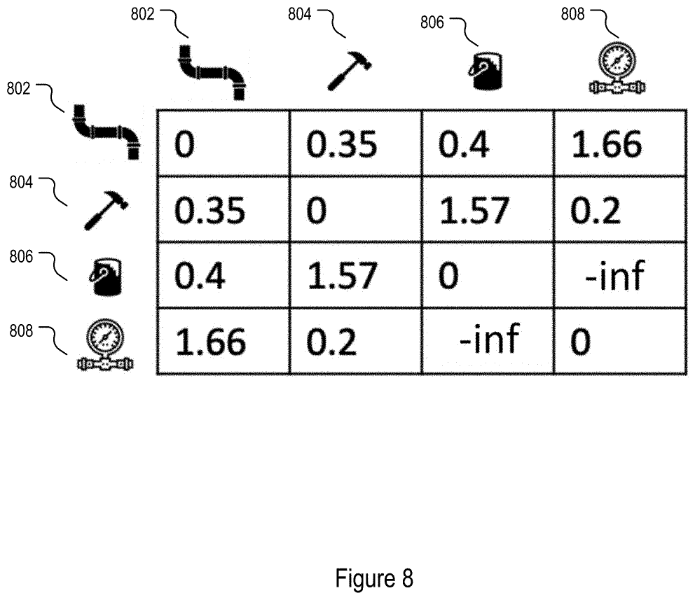

An exemplary PMI matrix is shown in FIG. 8. In this example, the PMI matrix is constructed as a symmetric matrix. The value of a matrix element at a particular column position and row position represents a complementarity between the two types of resources specified for the corresponding column and the row according to the collection of rule sets in the historical rule set database. A value of 0 may be specified for identical or ubiquitous construction resources (as shown in the diagonal elements in the PMI matrix of FIG. 8). A positive value indicates complementarity whereas a negative value indicates little or no complementarity (e.g., the pair of construction resources appear together less frequently). For example, as shown in FIG. 8, a pipe resource 802 is highly complementary to a gauge resource 808 (e.g., PMI value of 1.66, indicating that they appear together in rule sets frequently), and paint resource 806 is also highly complementary to a hammer resource 804 (e.g., PMI value of 1.57). On the other hand, the gauge resource 808 does not complement the paint resource 806 at all (e.g., PMI value of −Inf, indicating that they do not appear together at all in historical rule sets). In some implementations, a pair of resources having positive PMI value may be considered as a complementary resource pair. In some other application, a PMI threshold may be established and a pair off resources having a PMI value higher than the PMI threshold may be considered as a complementary resource pair.

In some implementations, the PMI matrix element for a construction resource “a” and a construction resource “b” may be calculated based on the following equations:

$$pmi ( a ; b ) = log \frac{p ( a , b ) }{p ( a ) p ( b )} , where$$

$$p ( a , b ) = \frac{\# of recipes containing a and b}{\# of recipes } , \\ p ( a ) = \frac{\# of recipes containing a}{\# of recipes} , \\ p ( b ) = \frac{\# of recipes containing b}{\# of recipes} .$$

In the equations above, function p( ) essentially represents probability values. For example, p(a,b) represents a probability that a and b appear in a same rule set in the historical rule sets. The term “recipes” in the equations above is used interchangeably with “rule sets”. The PMI matrix may be established for a collection of construction resources appearing in all historical rule sets. Based on the PMI matrix, a measure of existence of key complementary construction resources in the rule set maybe determined as:

Γ=Σᵢ₌₁^{Resources}^{_{old rule set}}Σⱼ₌ᵢ^{Resources}^{_{old rule set}}PMI(Resources_{old rule set}(i),Resources_{old rule set}(j))

The resource similarity σ between the base rule set and a historical rule set that combines both the overlap factor and complementary resource factor above may then be determined. In some implementations, the similarity σ, for example, may be calculated as:

σ=Jaccard Index+Γ

This similarity score may be further normalized to a scale of α (e.g., from 0-5) as:

$$sim ( Base Rule set , Historical Rule set ) = \frac{{σ}_{historicalruleset} * α}{max ( σ )}$$

Such a similarity score may be used in the selection of the set of historical rule sets for recommendation to user along with the base rule set as described above, and as visually shown in FIG. 7.

Returning to FIG. 2, the GUI 210 may include graphical user interface for importing a construction project including its layout for extraction of objects therein and for automatic generation of rule sets for these objects. The GUI 210, for example, may provide user control elements for browsing, displaying, and selecting project layouts from local or remote storages and project layout tools. The information contained in the layout selected by the user may then be used for generating the base rule sets in conjunction with other input data. Information about the objects included in the construction layout may be extracted automatically. The configuration information of the various objects from the construction layout may be further extracted from various manuals and catalogues stored in the backend database as described above. The GUI 210 may additionally provide user control elements for browsing, displaying, and selecting the various catalogs and manuals. The GUI 210 may further include user control elements for specifying project layout optimization parameters that may be used to automatically perform layout optimization and object extraction.

The GUI 210 may be further configured to provide graphical user interface to select from the automatically generated rule sets for different objects in the construction project for further modification and finalization. The rule sets may be generated based on the catalogues and manuals in the catalog database as described above. These rule sets may be shown in separate groups based on the types of corresponding objects (e.g. exchanger rule sets, air cooler rule sets in the context of a chemical plant project). Recommendations from the historical rule sets as described above may be further provided via the GUI 210 for user review and selection along with the base rule sets. Graphical user interface for modifying the rule sets for various objects by the user may also be provided via the GUI 210. User control elements in the GUI 210 may be further provided for the user to submit the final rule set for automatic generation of project schedule.

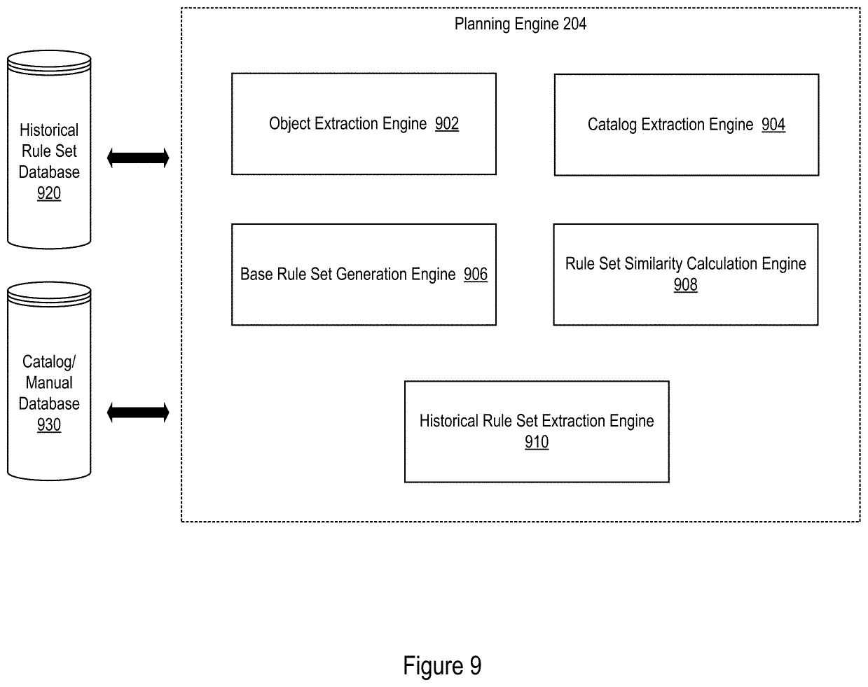

In accordance with the description above, FIG. 9 shows a computing system that may be used for implementing the planning engine 204 of FIG. 2. The planning engine 204 for example, may include an object extraction engine 902, a catalog extraction engine 904, a base rule set generation engine 906, a rule set similarity calculation engine 908, and a historical rule set extraction engine 910 in communication with one another and with the historical rule set database 920 and the catalog/manual database 930, to perform the various functions of the planning engine 204 as described above.

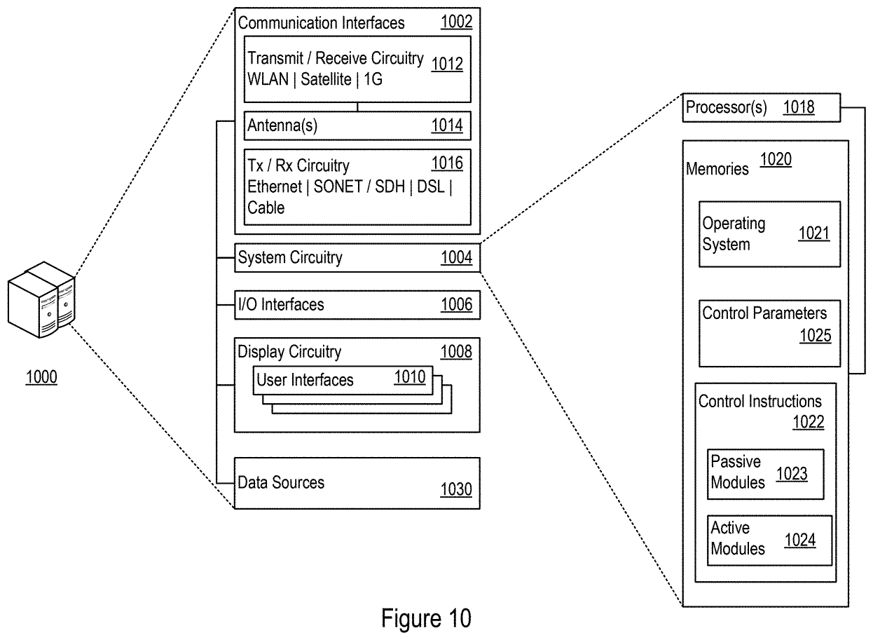

Finally, FIG. 10 illustrates an exemplary architecture of a computing device 1000 on which the features of the rule set generation and construction scheduling and their various functional modules are implemented. The computing device 1000 may include communication interfaces 1002, system circuitry 1004, input/output (I/O) interface circuitry 1006, and display circuitry 1008. The graphical user interfaces (GUIs) 1010 displayed by the display circuitry 1008 may be representative of GUIs generated by the project scheduling core and its various components to, for example, receive user commands/input and to display various outputs, as discussed above. The GUIs 1010 may be displayed locally using the display circuitry 1008, or for remote visualization, e.g., as HTML, JavaScript, audio, and video output for a web browser running on a local or remote machine. Among other interface features, the GUIs 1010 may further render displays of visual representations of, for example, the construction rule sets and project scheduling.

The GUIs 1010 and the I/O interface circuitry 1006 may include touch sensitive displays, voice or facial recognition inputs, buttons, switches, speakers and other user interface elements. Additional examples of the I/O interface circuitry 1006 includes microphones, video and still image cameras, headset and microphone input/output jacks, Universal Serial Bus (USB) connectors, memory card slots, and other types of inputs. The I/O interface circuitry 1006 may further include magnetic or optical media interfaces (e.g., a CDROM or DVD drive), serial and parallel bus interfaces, and keyboard and mouse interfaces.

The communication interfaces 1002 may include wireless transmitters and receivers (“transceivers”) 1012 and any antennas 1014 used by the transmit and receive circuitry of the transceivers 1012. The transceivers 1012 and antennas 1014 may support WiFi network communications, for instance, under any version of IEEE 802.11, e.g., 802.11n or 802.11ac, or other wireless protocols such as Bluetooth, Wi-Fi, WLAN, cellular (4G, LTE/A). The communication interfaces 1002 may also include serial interfaces, such as universal serial bus (USB), serial ATA, IEEE 1394, lighting port, I²C, slimBus, or other serial interfaces. The communication interfaces 1002 may also include wireline transceivers 1016 to support wired communication protocols. The wireline transceivers 1016 may provide physical layer interfaces for any of a wide range of communication protocols, such as any type of Ethernet, Gigabit Ethernet, optical networking protocols, data over cable service interface specification (DOCSIS), digital subscriber line (DSL), Synchronous Optical Network (SONET), or other protocol.

The system circuitry 1004 may include any combination of hardware, software, firmware, APIs, and/or other circuitry. The system circuitry 1004 may be implemented, for example, with one or more systems on a chip (SoC), application specific integrated circuits (ASIC), microprocessors, discrete analog and digital circuits, and other circuitry. The system circuitry 1004 may implement any desired functionality of the project scheduling core and its various components. As just one example, the system circuitry 1004 may include one or more instruction processor 1018 and memory 1020.

The memory 1020 stores, for example, control instructions 1022 for executing the features of the project scheduling core and its various components, as well as an operating system 1021. In one implementation, the processor 1018 executes the control instructions 1022 and the operating system 1021 to carry out any desired functionality for the project scheduling core. In another implementation the Control instructions may include passive modules 1023 and active modules 1024. The modules may include instructions that execute to configure the processor to perform the functions of the project scheduling core.

The computing device 1000 may further include various data sources 1030, or may be in communication with external data sources. Each of the databases that are included in the internal data sources 1030 or external data stores, such as the catalogs, manuals, and historical rule sets, may be accessed by the project scheduling core and its various components.

Accordingly, the method and system may be realized in hardware, software, or a combination of hardware and software. The method and system may be realized in a centralized fashion in at least one computer system or in a distributed fashion where different elements are spread across several interconnected computer systems. Any kind of computer system or other apparatus adapted for carrying out the methods described herein may be employed.

The method and system may also be embedded in a computer program product, which includes all the features enabling the implementation of the operations described herein and which, when loaded in a computer system, is able to carry out these operations. Computer program in the present context means any expression, in any language, code or notation, of a set of instructions intended to cause a system having an information processing capability to perform a particular function, either directly or after either or both of the following: a) conversion to another language, code or notation; b) reproduction in a different material form.

The rule set recommendation and scheduling implementations above provide an automated construction scheduling tool such that engineers do not need to manually collect activities and resources per object on the construction layout. The implementations add valuable engineering knowledge to the recommendation of rule sets from historical information rather than solely base the recommendation on catalogues and manuals in the database. The engineering knowledge comes from other engineering experience in creating construction rule sets for past projects. The implementations above provide a comparison between various rule sets in terms of resource similarity, resource costs, operation duration, and other factors. Such implementations help promote selection of not only the historical rule sets that have the most overlaps with the current project but also the rule sets that contain key complementary resources for building the specific object based on hidden knowledge accumulated from the past projects.

Many other modifications of the implementations above may be made to adapt a particular situation or material to the teachings without departing from the scope of the current disclosure. Therefore, it is intended that the present methods and systems not be limited to the particular embodiments disclosed, but that the disclosed methods and systems include all embodiments falling within the scope of the appended claims.

We claim:

1. A computer system, comprising:
a memory including instruction code; and
a processor in communication with the memory, wherein the processor, when executing the instruction code, is configured to:
receive layout data of a construction project via a Graphical User Interface (GUI);
extract an object from the layout data;
retrieve one or more construction data items associated with the object from a catalog database;
automatically generate a base construction rule set of the object based on the one or more construction data items;
identify at least one historical construction rule set from a historical construction rule set database based on a type of the object;
determine similarities between the base construction rule set and the identified at least one historical construction rule set;
generate a list of selected construction rule sets from the identified at least one historical construction rule set based on the similarities; and
provide the base construction rule set and the list of selected construction rule sets as candidate construction rule sets for user selection via the GUI.

2. The computer system of claim 1, wherein the one or more construction data items comprise a sequence of tasks for constructing the object extracted from a construction manual associated with the object in the catalog database.

3. The computer system of claim 2, wherein the one or more construction data items further comprise quantity and/or cost of a set of construction resources including at least one equipment, consumable material, construction procedure, or labor resource associated with the sequence of tasks.

4. The computer system of claim 3, wherein the base construction rule set comprises a sequence of construction operations each associated with one or more of the set of construction resources.

5. The computer system of claim 4, wherein the base construction rule set further comprises a cost for each of the sequence of construction operations.

6. The computer system of claim 1, wherein the processor is configured to determine the similarities between the base construction rule set and the identified at least one historical construction rule set by:
determining resource overlaps between the base construction rule set and the identified at least one historical construction rule set;
determining a measure of existence of complementary resource pairs in the base construction rule set; and
determining the similarities between the base construction rule set and the identified at least one historical construction rule set by combining the resource overlaps and the measure of existence of complementary resource pairs.

7. The computer system of claim 6, wherein the resource overlaps are determined by computing ratios between a number of overlapping construction resources of the base construction rule set and the identified at least one historical construction rule set and a number of construction resources of a union of, the base construction rule set and the identified at least one historical construction rule set.

8. The computer system of claim 6, wherein the measure of existence of complementary resource pairs in the base construction rule set is calculated based on a pointwise mutual information (PMI) matrix.

9. The computer system of claim 8, wherein the PMI matrix is established based on frequencies of co-appearance of construction resource pairs in historical construction rule sets associated with the type of the object in the historical construction rule set database.

10. The computer system of claim 1, wherein the processor is further configured to receive a user-selected or user-modified construction rule set for the object.

11. The computer system of claim 10, wherein the processor is further configured to automatically generate a construction schedule for the construction project based on the user-selected or user-modified construction rule set for the object and construction rule sets for other objects of the construction project.

12. The computer system of claim 10, wherein the processor is further configured to store the base construction rule set and different versions of the user-modified construction rule set for the object in the historical construction rule set database.

13. A method for automatically generating construction rule sets, comprising:
receiving layout data of a construction project via a Graphical User Interface (GUI);
extracting an object from the layout data;
retrieving one or more construction data items associated with the object from a catalog database;
generating a base construction rule set of the object based on the one or more construction data items;
identifying at least one historical construction rule set from a historical construction rule set database based on a type of the object;
determining similarities between the base construction rule set and the identified at least one historical construction rule set;
generating a list of selected construction rule sets from the at least one historical construction rule set based on the similarities; and
providing the base construction rule set and the list of selected construction rule sets as candidate construction rule sets for user selection via the GUI.

14. The method of claim 13, wherein the one or more construction data items comprise a sequence of tasks for constructing the object extracted from a construction manual associated with the object in the catalog database.

15. The method of claim 13, wherein determining the similarities between the base construction rule set and the identified at least one historical construction rule set comprises:
determining resource overlaps between the base construction rule set and the identified at least one historical construction rule set;
determining a measure of existence of complementary resource pairs in the base construction rule set; and
determining the similarities between the base construction rule set and the identified at least one historical construction rule set by combining the resource overlaps and the measure of existence of complementary resource pairs.

16. The method of claim 13, further comprising:
receiving a user-selected or user-modified construction rule set for the object; and
automatically generating a construction schedule for the construction project based on the user-selected or user-modified construction rule set for the object and construction rule sets for other objects of the construction project.

17. A non-transitory computer readable medium for storing instructions, wherein the instructions, when executed by a computer processor, causes the computer processor to:
receive layout data of a construction project via a Graphical User Interface (GUI);
extract an object from the layout data;
retrieve one or more construction data items associated with the object from a catalog database;
generate a base construction rule set of the object based on the one or more construction data items;
identify at least one historical construction rule set from a historical construction rule set database based on a type of the object;
determine similarities between the base construction rule set and the identified at least one historical construction rule set;
generate a list of selected construction rule sets from the identified at least one historical construction rule set based on the similarities; and
provide the base construction rule set and the list of selected construction rule sets as candidate construction rule sets for user selection via the GUI.

18. The non-transitory computer readable medium of claim 17, wherein the one or more construction data items comprise a sequence of tasks for constructing the object extracted from a construction manual associated with the object in the catalog database.

19. The non-transitory computer readable medium of claim 17, wherein the instructions are executed by the computer processor to determine the similarities between the base construction rule set and the identified at least one historical construction rule set by:
determining resource overlaps between the base construction rule set and the identified at least one historical construction rule set;
determining a measure of existence of complementary resource pairs in the base construction rule set; and
determining the similarities between the base construction rule set and the identified at least one historical construction rule set by combining the resource overlaps and the measure of existence of complementary resource pairs.

20. The non-transitory computer readable medium of claim 17, wherein the instructions are executed by the computer processor to further:
receive a user-selected or user-modified construction rule set for the object; and
automatically generate a construction schedule for the construction project based on the user-selected or user-modified construction rule set for the object and construction rule sets for other objects of the construction project.
